(19) United States
(12) Patent Application Publication
(10) Pub. No.: US 2003/0154166 A1
(43) Pub. Date: Aug. 14, 2003

(54) Method for allowing a cash adjustment between payment systems in communications network

(76) Inventors: Uwe Klatt, Berlin (DE); Thomas Ryll, Berlin (DE)

Correspondence Address: Kevin R. Spivak, Morrison & Foerster LLP, Suite 300, 1650 Tysons Boulevard, McLean, VA, 22102, US

(21) Appl. No.: 10/301,863

(22) Filed: Nov. 22, 2002

(30) Foreign Application Priority Data
Nov. 23, 2001 (EP) 01250412.2

(51) Int. Cl. G06F 17/60

(52) U.S. Cl. 705/40

(57) ABSTRACT

The invention relates to a method for allowing a cash adjustment, relating to a purchase transaction, between a first payment system in a first communication network and a second payment system, the first payment system having an associated purchaser and the second payment system having an associated vendor. The first payment system charges the purchaser and produces a first data record which relates to the purchase transaction and whose structure corresponding to data records which are used in telecommunication networks for billing for telecommunication connections. The second payment system credits a vendor account associated with the vendor and produces a second data record. The data records are then transmitted to a billing center provided for the purpose of billing for telecommunication services between telecommunication networks.

### CLAIM FOR PRIORITY

This application claims priority to European Application No. 01250412.2 which was filed in the German language on Nov. 23, 2001.

### TECHNICAL FIELD OF THE INVENTION

The invention relates to a method for allowing a cash adjustment, relating to a purchase transaction, between payment systems in communication networks.

### BACKGROUND OF THE INVENTION

By way of example, “electronic commerce” (E-commerce) involves purchase transactions being performed using communication networks. Such purchase transactions can relate, by way of example, to services or work (e.g. supply of information, data or goods) which incur a cost. Such communication networks used are, by way of example, the Internet or telecommunication networks (mobile radio networks, landline networks). For the purpose of payment, these purchase transactions can involve the use of, by way of example, cashless payment methods using mobile communication terminals (e.g. mobile telephones, PDAs—Personal Digital Assistants, portable computers—laptops, palmtops) or using computers connected to the Internet.

Often, purchasers and vendors do not perform the relatively complex payment transactions themselves but rather use payment service providers, which operate payment systems for handling payment transactions. Such payment transactions thus often involve the vendor (e.g. a trader, service provider, merchant), the purchaser (e.g. a customer, consumer) and a payment system belonging to a payment service provider, with both the vendor and the purchaser using the services of the payment service provider.

### SUMMARY OF THE INVENTION

The present invention discloses a method which provides a simple and reliable way of allowing a cash adjustment relating to a purchase transaction even when the purchaser and the vendor use services from different payment service providers, and hence a plurality of payment systems are involved in the payment transaction.

In one embodiment of the invention, there is a method for allowing a cash adjustment, relating to a purchase transaction, between a first payment system in a first communication network and a second payment system, the first payment system having an associated purchaser and the second payment system having an associated vendor, in which, upon arrival of a purchase message relating to the purchaser in the first payment system, this first payment system charges the purchaser a sum of money which is dependent on the purchase message, the first payment system produces a first data record which relates to the purchase transaction and whose structure corresponds to that of data records which are used in telecommunication networks for the purpose of billing for telecommunication connections, the first payment system transmits an acknowledgement message relating to the charge to the second payment system, the second payment system then credits a vendor account associated with the vendor, and the first payment system transmits the first data record to a billing center, provided for billing for telecommunication services between telecommunication networks, to allow the billing center to make a subsequent cash adjustment between the first payment system and the second payment system.

In one advantageous aspect of the invention, the structure of the first data record corresponds to that of data records which are used in telecommunication networks for billing for telecommunication connections and a billing center provided for billing for telecommunication services between telecommunication networks is also used to make the cash adjustment relating to a purchase transaction. Hence, the invention can be carried out in a particularly simple and inexpensive manner, since already known structures of data records and already known procedures can be used in billing centers, so that there is no need for any cost-intensive new development of new data record structures or new procedures in billing centers or for any trial and testing of such new structures or procedures. Instead, structures and procedures which have already been tried and tested and work can advantageously be embedded into the invention.

In one embodiment, the invention can involve the purchase message which relates to the purchaser being transmitted from the second payment system to the first payment system.

In another embodiment of the invention, the purchaser is charged by debiting the sum of money from a credit account associated with the purchaser in a first communication network. A particular advantage in this context is that the use of the purchaser's (e.g. prepaid) credit account means that there is no risk of payment default for the vendor. In addition, this embodiment allows the “prepaid” credit accounts, which are known in telecommunication networks for paying for call charges, to be used for charging the purchaser.

In still another embodiment of the invention, the purchaser is charged by recording the sum of money in a data store in the first communication network in order to allow later settlement with the purchaser. Such a method advantageously allows the payment sums relating to the purchase transaction to be settled with the purchaser after a time delay using invoices. This can be done using telecommunication network operators' invoicing systems known in telecommunication networks, for example.

In yet another embodiment of the invention, the second payment system produces a second data record which relates to the purchase transaction and whose structure corresponds to that of data records which are used in telecommunication networks for billing for telecommunication connections, and the second payment system transmits the second data record to the billing center. A particular advantage in this context is that, before the cash adjustment is made, the payment system can compare the first and second data records (which relate to the same purchase transaction, of course) with one another and check the contents of the data records for plausibility. It is also possible to ensure that the cash adjustment is made when the cash adjustment is desired by both payment systems. This is documented by the payment systems through transmission of the respective data record to the billing center. This prevents incorrect cash adjustments and increases the security of the method in accordance with the application.

In still another embodiment, the first data record and the second data record produced are data records which can be associated with one another.

In a further embodiment, the first data record and the second data record produced are data records having an identical data content.

This advantageously allows the billing center to make a simple comparison between the first and second data records in order to identify associated data records, i.e. those associated with one purchase transaction, to associate them with one another and to use them to make the cash adjustment. In this case, each data record includes the data which the billing center requires in order to make the cash adjustment. The redundant transmission of the data to the billing center even allows any transmission errors which occur during a data transmission to be identified and allows an error correction method to be started.

In another embodiment of the invention, the first data record can include data relating to the charge, and the second data record can include data relating to the credit. An advantage in this context is that, after the arrival of the first and second data records at the billing center, this billing center has access to the information required to allow the cash adjustment, and the first data record and the second data record nevertheless include a relatively small volume of data. This saves the resources of the communication network when transmitting the data records. In the case of this embodiment, the billing center can identify the associated first and second data records on the basis of an identifier (e.g. an identification number), for example, which is contained both in the first data record and in the second data record.

In another embodiment of the invention, the second payment system is associated with a second communication network, and the first data record is transmitted to the billing center using the first communication network, and the second data record is transmitted to the billing center using the second communication network. A particular advantage in this context is that the cash adjustment can be made possible even when the first payment system and the second payment system are associated with different communication networks, for example because the purchaser and the vendor use different communication networks for their respective communication operations.

### BRIEF DESCRIPTION OF THE DRAWINGS

The invention is explained further using the figure.

FIG. 1 shows a schematic illustration of an exemplary embodiment of the invention.

### DETAILED DESCRIPTION OF THE PREFERRED EMBODIMENTS

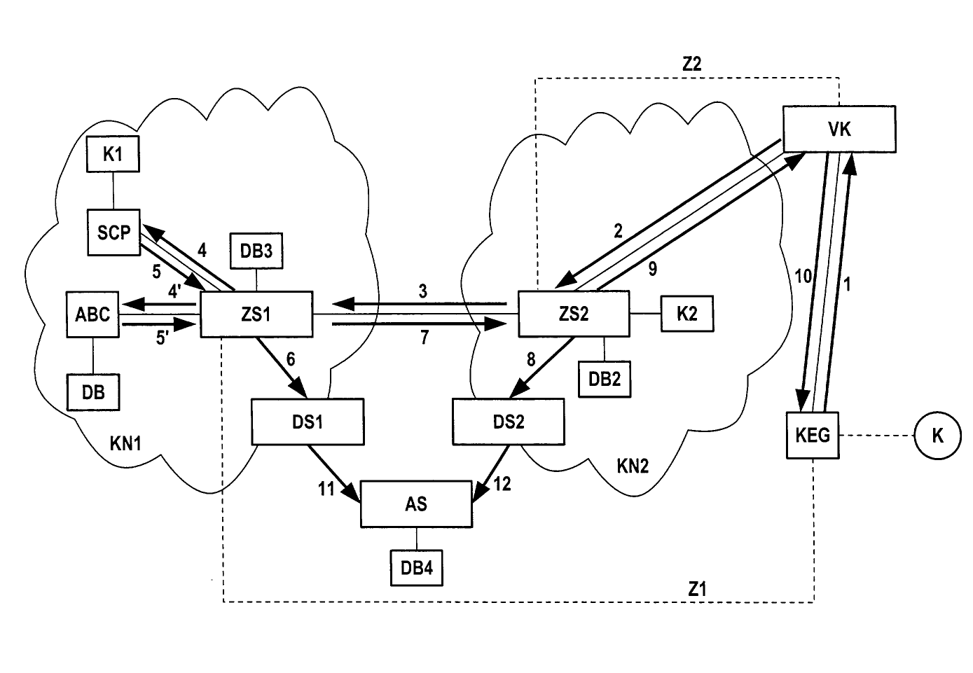

The left-hand side of the FIGURE shows a first communication network KN1 which includes a first payment system ZS1. In this case, the first payment system ZS1 can be in the form of a computer, for example, which is connected to the first communication network KN1 or which forms a “network node” in the first communication network KN1. The right-hand side of FIG. 1 shows, symbolically, a purchaser K who has access to a communication terminal KEG (e.g. a mobile telephone or a computer with Internet access) which he uses to contact a vendor VK (or the latter's vendor communication terminal, which is not shown in more detail) in order to perform purchase transactions. Performance of the purchase transaction does not necessarily require the use of a mobile telephone. Use of a mobile telephone is just one of many possibilities. In this exemplary embodiment, the first communication network KN1 is the mobile telephone home network for the purchaser K (the purchaser K is thus a mobile radio subscriber with an operator of the communication network KN1). The purchaser K therefore uses the services of a payment service provider associated with the first communication network KN1. This payment service provider uses the first payment system ZS1 to handle payment transactions. The purchaser's communication terminal KEG is therefore associated with the first payment system ZS1. This association is symbolized by a dashed line Z1. The first communication network KN1 can be, by way of example, a mobile telephone home network for the purchaser K, for example a GSM network (GSM=Global System for Mobile communication).

The vendor VK settles his payment transactions using the services of a second payment provider, which is associated with the second communication network KN2. In this case, this second payment service provider uses the technical facilities of a second payment system ZS2, which forms a network node in the second communication network KN2, for example. Since the vendor VK regularly uses the second payment system ZS2 to handle his payment transactions, the vendor VK (or his communication terminal) is associated with the second payment system ZS2. This is symbolized by the dashed line Z2. The second communication network KN2 can be, by way of example, a mobile telephone home network for the vendor VK, for example a GSM network.

To perform a purchase transaction, the purchaser K uses his communication terminal KEG to send a purchase request message 1 to the vendor VK. The vendor VK ascertains the purchase sum associated with this purchase request and sends a payment message 2 including information about the purchase sum and the purchaser K to the second payment system ZS2. The second payment system ZS2 recognizes that the purchaser's communication terminal KEG is not associated with the second payment system ZS2. Instead, the second payment system ZS2 identifies, for example from a mobile radio call number MSISDN for the communication terminal KEG which is delivered with the payment message 2 (and represents information about the purchaser K), that the first communication network KN1 is the home network for the communication terminal KEG. The second payment system ZS2 then sends a purchase message 3, including information about the sum of money and the purchaser or his communication terminal KEG, to the first payment system ZS1 in the first communication network KN1. This is done because the second payment system ZS2 has the information available that the first payment system ZS1, associated with the communication terminal KEG, is in its home network (that is to say in the first communication network KN1). The information that the communication terminal KEG is associated with the first payment system ZS1 can also be obtained by the second payment system ZS2 in another way. By way of example, it can read this information from a second database DB2 in the second communication network KN2, the second database DB2 storing data about purchasers, their communication terminals and the payment systems associated with these communication terminals.

The first payment system ZS1 now reads, e.g. from a data store DB3, the information that the purchaser K preferably handles his payment transactions using a credit account K1 associated with him, and it therefore sends a debit message 4 to a service control point SCP in the first communication network KN1, which has the structure of an intelligent network IN, and thus prompts the purchaser to be charged. The service control point SCP then debits the sum of money from the purchaser's credit account K1. Following successful debiting, the service control point SCP sends a debit success message 5 to the first payment system ZS1. The first payment system ZS1 then produces a first data record DS1 relating to the purchase transaction. This data record DS1 has the format of a “TAP-3” data record (TAP3-Record).

In mobile radio networks based on the GSM standard, “TAP3” data records are used, inter alia, to allow a “roaming” method used for setting up communication connections across networks to involve billing of the telecommunication charges between the communication networks concerned by using these “TAP3-Records” to transmit, by way of example, the length of time for the telecommunication connections to a telecommunication connection billing center. The mobile radio networks contain “roaming mechanisms” which allow a customer belonging to a first mobile radio network to use telecommunication services (such as use of voice telecommunication connections or telephone answering functions—voice mail box) in another mobile radio network. Financial adjustment for the use of the services is made between the respective networks by virtue of data records which have a particular format being sent by the network operators of the telecommunication networks to an external billing center (a “clearing house”), and this billing center then organizing adjustment payments between the network operators. In telecommunication networks based on the GSM standard, data records (“TAP-Records”) in the TAP3 data format are used. In North American telecommunication networks, which use the methods of “Analog AMS”, “IS-136TDMA” or “IS-95CDMA”, data records in the CIBER format (CIBER=Cellular Intercarrier Billing Exchange Roamer) are used.

Billing for voice telecommunication connections using TAP data records is described in the standard GSM 12.05 (ETSI TS 100 616 V7.0.1 (1999-07), Technical Specification, “Digital cellular telecommunications system (Phase 2+); Event and call data), particularly in section 6.1.2 “Accounting”.

In line with the invention, the data record DS1 thus has the structure of data records such as are used in telecommunication networks for billing for telecommunication connections, but includes information about the purchase transaction, which is independent of telecommunication connections. The factor to be billed which is stored in this first data record DS1 is the payment sum relating to the purchase transaction (for example [symbol] 100) (in contrast to the TAP3-Records, which contain details about the duration of the telecommunication connections set up, for example). The first data record DS1 includes the information about the purchase transaction which the billing center AS requires in order to make a cash adjustment between the first payment system ZS1 and the second payment system ZS2 later. This information includes information about the two payment systems involved in the later cash adjustment (that is to say in this case the first payment system ZS1 and the second payment system ZS2) and also about the sum of money (e.g. [symbol] 100) and the “direction of payment” (i.e. the payment system ZS1 needs to pay the sum of money amounting to [symbol] 100 to the payment system ZS2). In addition, the first data record DS1 can also contain information about the purchaser K and the vendor VK, about the item to which the purchase transaction relates and about the date and time of the sum of money being debited from the credit account K1.

By transmitting an acknowledgement message 7, the first payment system ZS1 informs the second payment system ZS2 about the charge made to the purchaser (i.e. successful debiting of the sum of money from the purchaser's credit account K1). The second payment system ZS2 then credits a vendor account K2 associated with the vendor VK; the sum of money is credited to this vendor account K2 (if appropriate, deducting charges for performing the payment transaction). From this time onward, the vendor VK can have access to this sum of money. The second payment system ZS2 then produces a second data record DS2, whose structure likewise corresponds to that of data records which are used in telecommunication networks for the purpose of billing for telecommunication connections. This second data record DS2 can be of identical form to the data record DS1, i.e. it can likewise have the structure of a TAP3-Record and can have the same data contents as the first data record DS1. The second payment system ZS2 then sends a notification message 9 to the communication terminal belonging to the vendor VK which informs the vendor about the successful payment relating to the purchase transaction. The vendor VK can now use an informative message 10 to inform the purchaser K about, by way of example, the purchaser's successful payment and about the delivery status of the product or the status of performance of the service. If the payment transaction has involved the purchaser buying information or data, then this information and data can be transmitted directly to the communication terminal KEG belonging to the purchaser K with the informative message 10.

The first payment system ZS1 transmits the first data record DS1 to the billing center AS and the second payment system ZS2 transmits the second data record DS2 to the billing center AS (arrows 11 and 12). This transmission can be effected directly after the first data record and the second data record DS2 have been produced. Alternatively, it can be effected with a time delay at particular prescribed time intervals. The data records DS1 and DS2 can be transmitted to the billing center AS using the known data transmission methods FTP (FTP=File Transfer Protocol) or FTAM (FTAM=File Transfer, Access and Management), for example.

It is likewise possible for the billing center AS to request the first data record DS1 together with other data records produced by the first payment system ZS1 at particular prescribed times. Similarly, the billing center AS can ask the second payment system ZS2 for the second data record DS2 together with other data records produced by the second payment system ZS2. The data records are collected and stored by the billing center AS, and the billing center AS makes the cash adjustment between the first payment system ZS1 and the second payment system ZS2 at further prescribed times (e.g. at the end of the month).

This can be done, by way of example, by virtue of the billing center AS, when evaluating all data records relating to a particular period (which have been transmitted to it and are stored in data stores DB4 in the billing center), adding up those sums of money which need to be transferred from the first payment system ZS1 to the second payment system ZS2 for the cash adjustment (since the first payment system ZS1—as shown in the FIGURE—has associated purchasers who perform purchase transactions with vendors associated with the second payment system ZS2). Similarly, the billing center AS adds up those sums of money which need to be transferred from the second payment system ZS2 to the first payment system ZS1 for the cash adjustment (since the second payment system ZS2—not shown in the FIGURE—also had associated purchasers in the respective time interval who performed purchase transactions with vendors associated with the first payment system ZS1). The billing center AS then forms the difference between the first sum of money, which needs to be transferred from the first payment system ZS1 to the second payment system ZS2, and the second sum of money, which needs to be transferred from the second payment system ZS2 to the first payment system ZS1, and transfers this difference either from the first payment system ZS1 to the second payment system ZS2 or from the second payment system ZS2 to the first payment system ZS1. The direction of the transfer of money is obtained from the arithmetic sign of the difference value. The balance between the first payment system ZS1 and the second payment system ZS2 is thus calculated and the level of this balance value is then used by the billing center AS to make the cash adjustment.

In another embodiment, the billing center AS can make the cash adjustment between the first payment system and the second payment system as soon as the first data record DS1 has been received from the first payment system ZS1 if the first data record includes the data required for such adjustment. In this case, a second data record relating to the same purchase transaction need be neither produced nor transmitted to the billing center AS.

If the first payment system ZS1 in the first communication network KN1 includes the information that the purchaser K normally makes payments by invoice (and not using the credit account K1, as described above), then the first payment system ZS1 can send a message 4′, similar to the message 4, to an invoice collection center ABC instead of to the service control point SCP. This prompts the invoice collection center ABC (ABC=Administration and Billing Center) to record the sum of the payment for subsequent settlement with the purchaser. At a later time, the invoice collection center ABC then produces an invoice and sends it to the purchaser K. The invoice collection center ABC sends a message 5′, of similar form to the message 5, to the first payment system ZS1 immediately (in real time) after the sum of money has been recorded, and the method is then continued in the known manner. Such a refinement of the method allows the invoicing method customary in many telecommunication networks to be used also for allowing the cash adjustment in the inventive method.

To allow the cash adjustment, banks or credit card organizations can also be used by virtue of the first payment system ZS1 sending appropriate messages to technical facilities for the banks or credit card organizations. The first payment system ZS1 can also perform currency conversions if the purchaser uses a different currency than the vendor.

A particular advantage of the invention is that existing technical facilities used for billing for voice telecommunication connections, for example, in the case of roaming methods can also be used to allow a cash adjustment, relating to a purchase transaction, between various payment systems in various communication networks. This can involve the use both of already existing billing centers (clearing houses) and of already existing data record formats, which means that the inventive method can be implemented easily, very inexpensively and—because already tested technical facilities and procedures are being used—with little complexity.

In addition, existing roaming agreements between the network operators in the communication networks can be used. These may need to be extended so that they cover not only telecommunication services but also cash adjustment operations relating to purchase transactions.

The billing centers do not need to be independent technical facilities separate from the communication networks (as shown in the FIGURE). The function of the billing center can similarly also be performed by a facility within a network.

What is claimed is:

1. A method for allowing a cash adjustment, relating to a purchase transaction, between a first payment system in a first communication network and a second payment system, the first payment system having an associated purchaser and the second payment system having an associated vendor, comprising:
charging the purchaser a sum of money which is dependent on the purchase message, upon arrival of a purchase message relating to the purchaser in the first payment system;
producing a first data record which relates to the purchase transaction, the first data record having a structure corresponding to data records used for billing in telecommunication connections;
transmitting an acknowledgement message relating to the charge to the second payment system;
crediting a vendor account associated with the vendor; and
transmitting the first data record to a billing center, to bill for telecommunication services between telecommunication networks, and to allow the billing center to make a subsequent cash adjustment between the first payment system and the second payment system.

2. The method as claimed in claim 1, wherein the purchase message which relates to the purchaser is transmitted from the second payment system to the first payment system.

3. The method as claimed in claim 1, wherein the purchaser is charged by debiting the sum of money from a credit account associated with the purchaser in a first communication network.

4. The method as claimed in claim 1, wherein the purchaser is charged by recording the sum of money in a data store in the first communication network to allow later settlement with the purchaser.

5. The method as claimed in claim 1, wherein the second payment system produces a second data record which relates to the purchase transaction and has a structure corresponding to data records used in telecommunication networks for billing telecommunication connections, and
the second payment system transmits the second data record to the billing center to allow the billing center to make a subsequent cash adjustment between the first payment system and the second payment system.

6. The method as claimed in claim 5, wherein the first data record and the second data record produced are data records which can be associated with one another.

7. The method as claimed in claim 5, wherein the first data record and the second data record produced are data records having an identical data content.

8. The method as claimed in claim 5, wherein the first data record includes data relating to the charge, and the second data record includes data relating to the credit.

9. The method as claimed in claim 5, wherein the second payment system is associated with a second communication network, and the first data record is transmitted to the billing center using the first communication network, and the second data record is transmitted to the billing center using the second communication network.
